(19) United States
(12) Patent Application Publication
(10) Pub. No.: US 2024/0361618 A1
(43) Pub. Date: Oct. 31, 2024

(54) DOUBLE-SIDED CONDUCTING FILMS

(71) Applicant: Gentex Corporation, Zeeland, MI (US)

(72) Inventors: Ryan Barrido Balili, Holland, MI (US); Gary J. Dozeman, Zeeland, MI (US); David J. Cammenga, Holland, MI (US)

(73) Assignee: Gentex Corporation, Zeeland, MI (US)

(21) Appl. No.: 18/644,712

(22) Filed: Apr. 24, 2024

Related U.S. Application Data
(60) Provisional application No. 63/498,895, filed on Apr. 28, 2023.

(51) Int. Cl. G02F 1/00; G02F 1/166

(52) U.S. Cl. CPC G02F 1/0018; G02F 1/166

(57) ABSTRACT

An electro-optic assembly includes a first substrate that is conductive and has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A first conductive film is coupled to the first surface.

### CROSS-REFERENCE TO RELATED APPLICATION

This application claims priority to and the benefit under 35 U.S.C. § 119 (e) of U.S. Provisional Application No. 63/498,895, filed on Apr. 28, 2023, entitled “DOUBLE-SIDED CONDUCTING FILMS,” the disclosure of which is hereby incorporated herein by reference in its entirety.

### FIELD OF THE DISCLOSURE

The present disclosure generally relates to an electro-optic assembly, and, more particularly, to an electro-optic assembly with a conductive substrate and film.

### SUMMARY OF THE DISCLOSURE

According to one aspect of the present disclosure, an electro-optic assembly includes a first substrate that has a first surface and a second surface opposite the first surface and the first substrate is conductive from the first surface to the second surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode.

According to another aspect of the present disclosure, an electro-optic assembly includes a first substrate that has a first surface and a second surface opposite the first surface and a plurality of conduction paths extending from the first surface to the second surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode.

According to yet another aspect of the present disclosure, an electro-optic assembly template includes a first substrate having a first surface and a second surface opposite the first surface and a plurality of conduction paths extending from the first surface to the second surface. At least one conductive element is located in each of the conduction paths, and a plurality of turns form a roll.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electro-optic assembly of a first construction in accordance with the present disclosure;

FIG. 2A is a top view of a vehicle incorporating an electro-optic assembly in accordance with the present disclosure;

FIG. 2B is an upper perspective view of an aircraft incorporating an electro-optic assembly in accordance with the present disclosure;

FIG. 2C is an elevational view of a building incorporating an electro-optic assembly in accordance with the present disclosure;

FIG. 2D is an upper perspective view of an eyewear assembly incorporating an electro-optic assembly in accordance with the present disclosure;

FIG. 3 is a cross-sectional view of conduction paths in a substrate of an electro-optic assembly in accordance with the present disclosure;

FIG. 4A is a top view of a substrate of an electro-optic assembly that includes a first distribution of conduction paths in accordance with the present disclosure;

FIG. 4B is a top view of a substrate of an electro-optic assembly that includes a second distribution of conduction paths in accordance with the present disclosure;

FIG. 4C is a top view of a substrate of an electro-optic assembly that includes a third distribution of conduction paths in accordance with the present disclosure;

FIG. 4D is a top view of a substrate of an electro-optic assembly that includes a fourth distribution of conduction paths in accordance with the present disclosure;

FIG. 5A is a cross-sectional view of an electro-optic assembly of a second construction in accordance with the present disclosure;

FIG. 5B is a cross-sectional view of an electro-optic assembly of a third construction in accordance with the present disclosure;

FIG. 6A is a cross-sectional view of an electro-optic assembly with a first arrangement of connecting the electrical contacts in accordance with the present disclosure;

FIG. 6B is a cross-sectional view of an electro-optic assembly with a second arrangement of connecting the electrical contacts in accordance with the present disclosure;

FIG. 6C is a cross-sectional view of an electro-optic assembly with a third arrangement of connecting the electrical contacts in accordance with the present disclosure;

FIG. 6D is a cross-sectional view of an electro-optic assembly with a fourth arrangement of connecting the electrical contacts in accordance with the present disclosure;

FIG. 7A is an upper perspective of an electro-optic template in accordance with the present disclosure; and

FIG. 7B is an upper perspective of an electro-optic template in a roll in accordance with the present disclosure.

### DETAILED DESCRIPTION

The present illustrated embodiments reside primarily in combinations of method steps and apparatus components related to an electro-optic assembly with a conductive substrate and film. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

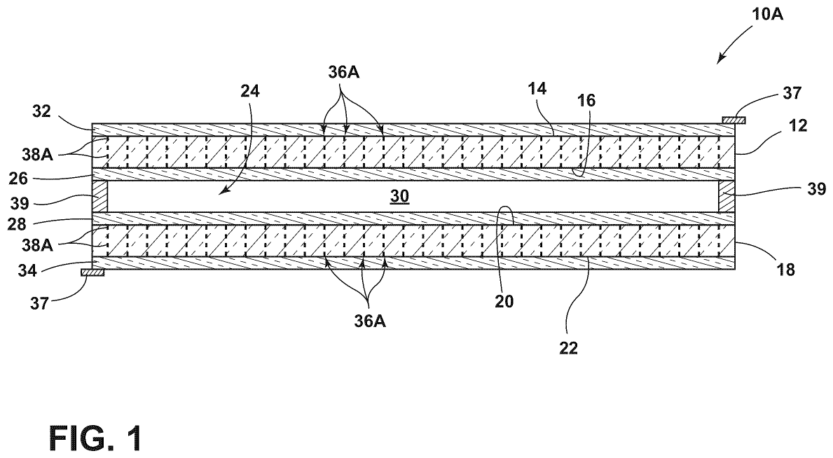

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

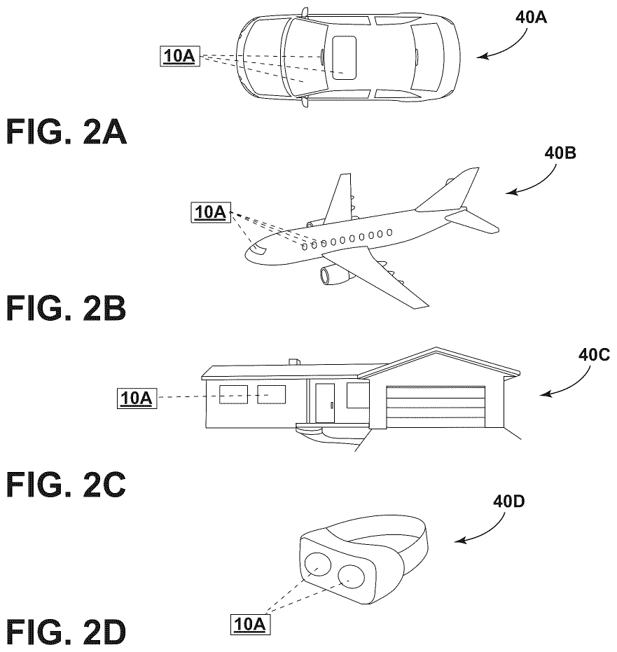

Referring to FIGS. 1-2D, reference numeral 10A generally designates an electro-optic assembly in accordance with a first construction. The electro-optic assembly 10A includes a first substrate 12 (e.g., a first transparent conductive substrate) that has a first surface 14 and a second surface 16 opposite the first surface 14. The first substrate 12 is conductive from the first surface 14 to the second surface 16. A second substrate 18 has a third surface 20 and a fourth surface 22 opposite the third surface 20. The second and third surfaces 16, 20 face each other to define a gap 24. A first electrode 26 is coupled to the second surface 16 and a second electrode 28 is coupled to the third surface 20. An electro-optic medium 30 is located between the first electrode 26 and the second electrode 28. A first conductive film 32 may be coupled to the first surface 14.

With continued reference to FIGS. 1-2D, the second substrate 18 may, likewise, be conductive (e.g., a second transparent conductive substrate) that is conductive from the third surface 20 to the fourth surface 22. A second conductive film 34 may be connected to the fourth surface 22. In this manner, the first and second conductive films 32, 34 may each be energized by electrical contacts 37 and the first and second transparent conductive substrates 12, 18 conduct the energy to the first and second electrodes 26, 28 to power the electro-optic medium 30. The electro-optic medium 30 is configured to switch states upon energizing. For example, the electro-optic assembly 10A may be electro-chromic and the electro-optic medium 30 may be switchable between a transmissive state (e.g., greater than 40%, 50%, 60% transmission in a visible spectrum) and a reflective state (e.g., in conjunction with a transreflective layer on, for example, the third surface 20). In some embodiments, the electro-optic assembly 10A is switchable between the transmissive state (e.g., greater than 40%, 50%, 60% transmission in a visible spectrum) and a substantially darkened state. The first and second transparent conductive substrates 12, 18 may be anisotropically conductive. For example, the first and second transparent conductive substrates 12, 18 may each define a plurality of conduction paths 36A in a first configuration. In some embodiments, the conduction paths 36A may be formed with conductive elements 38A suspended in the first and second transparent conductive substrates 12, 18. The conductive elements 38A may be formed of ferromagnetic materials and/or a composite of ferromagnetic and non-ferromagnetic conducting materials that can be aligned when the first and second transparent conductive substrates 12, 18 are in a non-solid state (e.g., a molten state, a preform state, or a prepolymerized state). For example, the conductive elements 38A may be formed of metals, such as composite beads that become aligned into conduction paths 36A upon the introduction of an electric or magnetic field before the first and second transparent conductive substrates 12, 18 are solidified/formed. In some embodiments, the first and second transparent conductive substrates 12, 18 may be formed of Polyethylene Terephthalate (“PET”), Polycarbonate (“PC”), other plastics, glass, epoxy, and/or the like. In some embodiments, the electro-optic medium 30 may include a solution-phase, liquid or gel-based medium requiring an outer seal 39 and/or a laminate (e.g., EVA, TPU, or the like). In other embodiments, electro-optic medium 30 may include a film based medium or a solid-state based medium, thus not requiring the outer seal 39. The electro-optic assembly 10A may be laminated (e.g., between or around the first and second transparent conductive substrates 12, 18) to reduce gas and moisture permeation through the first and second transparent conductive substrates 12, 18 (e.g., the conduction paths 36A).

With reference now to FIGS. 2A-2D, the electro-optic assembly 10A may be incorporated with one or more structures 40A-40C. For example, FIG. 2A illustrates an automobile 40A employing the electro-optic assembly 10A, for example, with an interior rearview mirror, a sunroof, a windshield, a side window, a heads-up display, and/or other interior vehicle locations that display one or more aspects of the electro-optic assembly 10A. The automobile 40A may include a commercial vehicle, an emergency vehicle, a residential vehicle, or the like. FIG. 2B illustrates an aircraft 40B or another non-terrestrial transportation like a watercraft or a spacecraft employing the electro-optic assembly 10A (e.g., a front window, side window, heads-up display). FIG. 2C illustrates a building 40C employing electro-optic assembly 10A (e.g., a window). The building 40C may be a residential building, a commercial building, and/or the like. Generally speaking, the electro-optic assembly 10A may be incorporated into any environment where it is beneficial to change the state of a window, mirror, and/or display. FIG. 2D illustrates eyewear 40D employing electro-optic assembly 10A. For example, the eyewear 40D may include glasses with dimming functionality, augmented reality, or semi-augmented reality. Generally speaking, other structures, may incorporate the electro-optic assembly 10A where switching between transmission and/or reflective states may be beneficial. The first and second conductive films 32, 34 and the first and second electrodes 26, 28 may be formed of various materials, for example, transparent, reflective, or transreflective materials depending on the application and states. For example, these materials may include zinc oxide, indium tin oxide (ITO), fluorine doped tin oxide, indium zinc oxide, conductive polymers, thin metal films, metal grid/mesh, metal networks, carbon nanotubes, nanowires, or graphene which are some examples of materials used for transparent conductors.

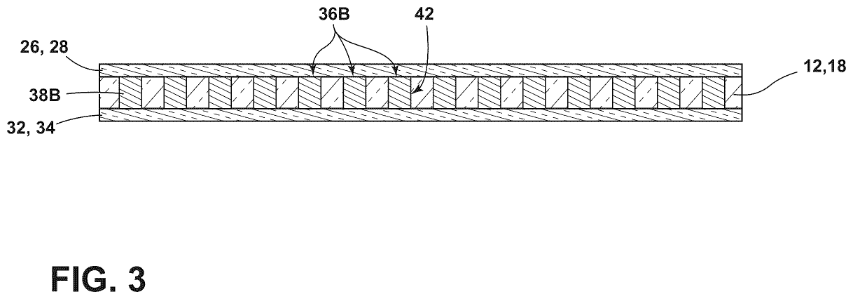

With reference now to FIG. 3, a plurality of conduction paths 36B are illustrated in a second configuration. Unless otherwise indicated, the conduction paths 36B in the second configuration may be implemented in the same structures and electro-optic assembly 10A of the conduction paths 36B in the first configuration. However, in the second configuration, the conduction paths 36B are formed with conductive elements 38B deposited in apertures 42 defined by the first and second transparent conductive substrates 12, 18. The conductive elements 38B may be formed of a conductive ink, a conductive epoxy, a conductive paste, a conductive adhesive, a conductive polymer, such as poly(3,4-ethylenedioxythiophene) (“PEDOT”), poly(3,4-ethylenedioxythiophene) polystyrene sulfonate (“PEDOT: PSS”), and/or the like.

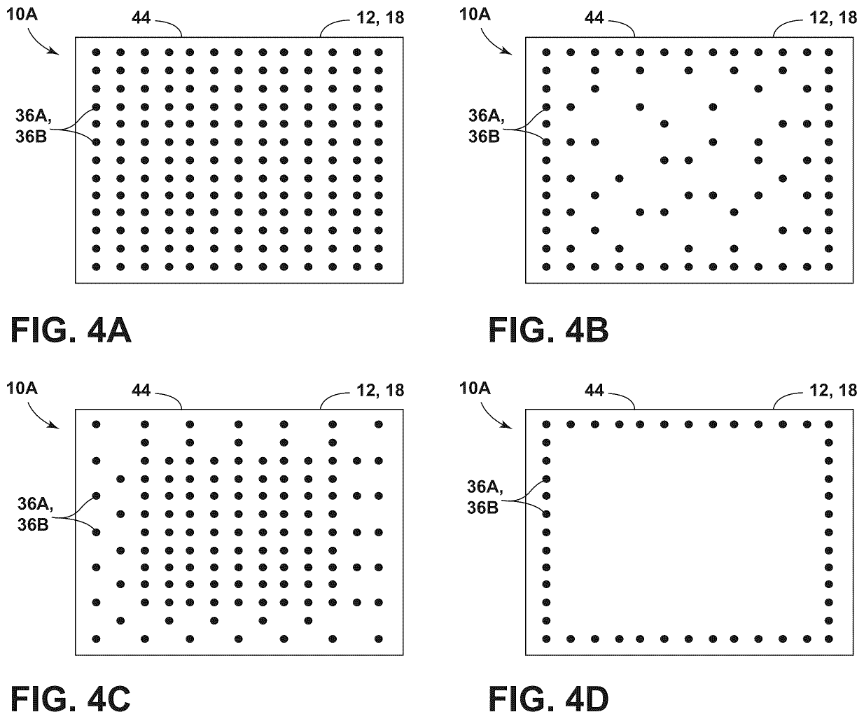

With reference now to FIGS. 4A-4D, the conduction paths 36A, 36B in any configuration and construction described herein may have a variety of distributions. More particularly, the first and second transparent conductive substrates 12, 18 may define an outer perimeter 44 and the conduction paths 36A, 36B are formed within the outer perimeter 44 in a uniform distribution or non-uniform distribution. With reference to FIG. 4A, the conduction paths 36A, 36B are shown in a uniform distribution where each of the conduction paths 36A, 36B are equally spaced. In the uniform distribution, the conduction paths 36A, 36B may be in equally spaced rows and columns, or may, alternatively, be equally spaced in different lattice geometries (e.g., hexagonal) and/or matrixes. The distribution of conduction paths 36A, 36B could be random or a combination arrangement/sections of random and regular patterns. With reference now to FIG. 4B, the conduction paths 36A, 36B are shown in a first non-uniform distribution where a concentration of the conduction paths 36A, 36B near the outer perimeter 44 is greater than in a central region. In some embodiments, the concentration may progressively get smaller towards the central region. With reference now to FIG. 4C, the conduction paths 36A, 36B are shown in a third non-uniform distribution where a concentration of the conduction paths 36A, 36B near the outer perimeter 44 is less than in a central region. In some embodiments, the concentration may progressively get smaller towards the outer perimeter 44. With reference now to FIG. 4D, the conduction paths 36A, 36B are shown in a fourth non-uniform distribution where the conduction paths 36A, 36B are only located near the outer perimeter 44. The location of the conduction paths 36A, 36B dictates which regions of the electro-optic medium 30 will change states first. In some embodiments, the first substrate 12 may have the uniform distribution, the first non-uniform distribution, or the second non-uniform distribution, and the second substrate 18 may have a different one of the distributions.

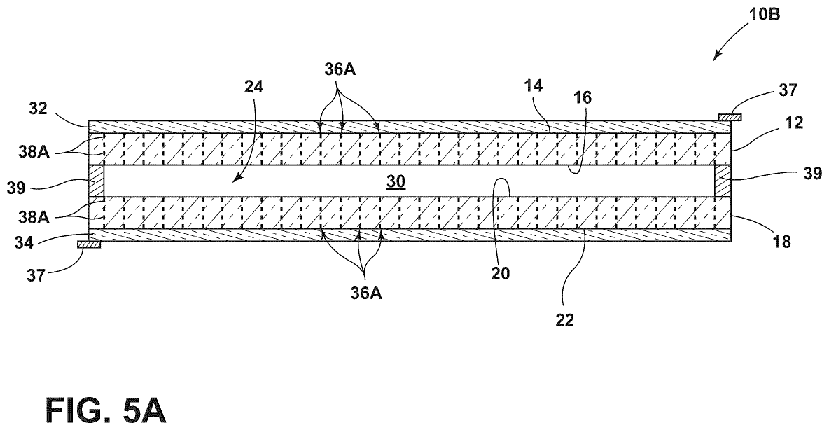

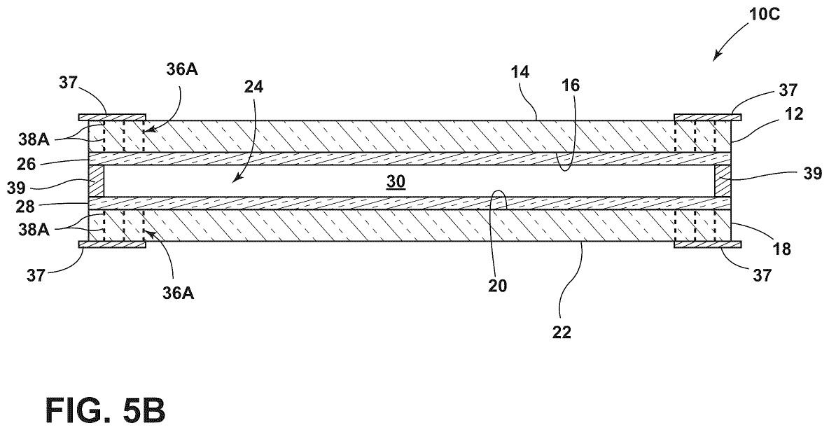

With reference now to FIG. 5A, an electro-optic assembly 10B in accordance with a second construction is illustrated. Unless otherwise specified, the electro-optic assembly 10B may share all the same features, structures, materials, and be incorporated into the same structures as the electro-optic assembly 10A of the first construction. However, under the second construction, the electro-optic assembly 10B may not include the first and/or second electrodes 26, 28. More particularly, the electro-optic medium 30 may be in contact with and energized directly from (e.g., through) the first and/or second substrates 12, 18.

With reference now to FIG. 5B, an electro-optic assembly 10C in accordance with a third construction is illustrated. Unless otherwise specified, the electro-optic assembly 10C may share all the same features, structures, materials, and be incorporated into the same structures as the electro-optic assembly 10A, 10B of the previous constructions. However, under the third construction, the electro-optic assembly 10C may not include the first and/or second conductive films 32, 34. More particularly, the first and second electrodes 26, 28 may be in contact with and energized directly from (e.g., through) the first and/or second substrates 12, 18 without the conductive films 32, 34.

With reference now to FIGS. 1, 5A, and 5B, the electro-optic assembly 10A-10C of any construction may include a stack in the first and/or second substrates 12, 18. The stack may include a plurality of first substrates 12 and/or second substrates 18 (e.g., ply's) each separated by a conductive film 32, 34. For example, the first substrate 12 may include two, three, or more first substrate ply's each separated by the first conductive films 32. Each first substrate ply may define the conduction paths 36A, 36B. Likewise, the second substrate 18 may include two, three, or more second substrate ply's each separated by the second conductive films 34. Each second substrate ply may define the conduction paths 36A, 36B.

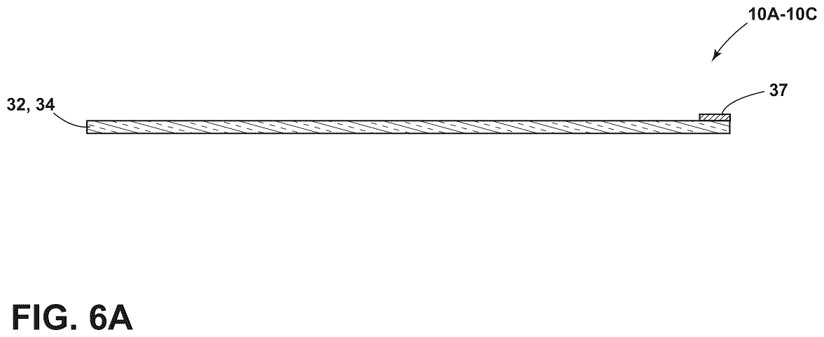

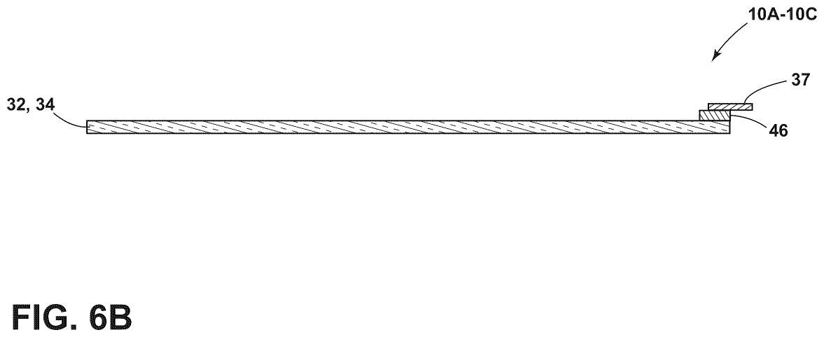

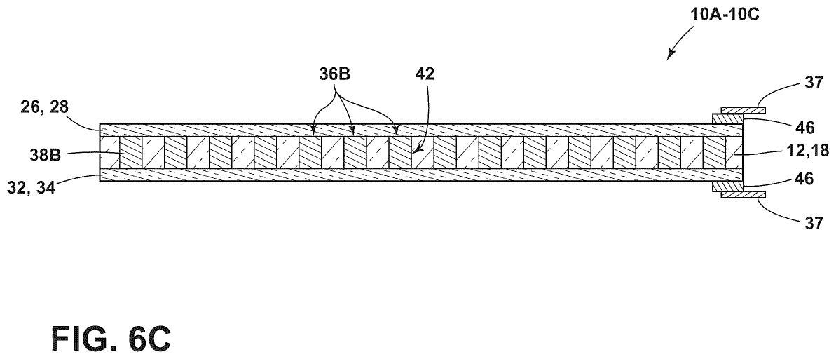

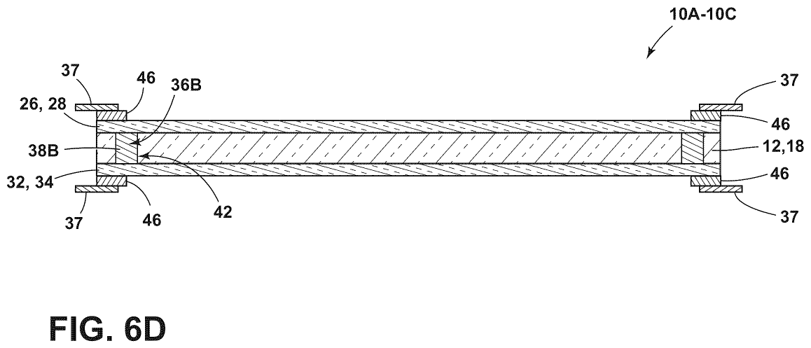

With reference now to FIGS. 6A-6D, the electro-optic assembly 10A-10C of either construction may include various arrangements of connecting the electrical contacts 37 and ultimately energizing the electro-optic medium 30. The electrical contacts 37 may be formed of conductive structures such as one or more conductive clips, other metal structures, a conductive coating, a conductive ink, a solder, a conductive epoxy, a conductive paste, a conductive adhesive, a conductive tape, buses, conductive springs, the like, and/or combinations thereof. The electrical contacts 37 (e.g., buses) may be applied to any of the conducting surfaces (e.g., the first surface 14, the fourth surface 22, the conductive films 32, 34, the electrodes, 26, 28, and/or the like). The electrical contacts 37 (e.g., buses) may extend along a portion of the perimeter of the electro-optic assembly 10A-10C (e.g., a perimeter of the first surface 14, the fourth surface 22, the conductive films 32, 34, the electrodes, 26, 28, combinations thereof, and/or the like).

With reference now to FIG. 6A, the electrical contacts 37 may connect directly to the first and second conductive films 32, 34. With reference to FIG. 6B, the electrical contacts 37 may connect indirectly to the first and second conductive films 32, 34. More particularly, the electrical contacts 37 may connect to one or more conductive intermediaries 46, such as a bus, a metal coating, a conductive tape, a conductive epoxy, a conductive paste, solder, combinations thereof, and/or other materials with low resistance (e.g., lower than the first and second conductive films 32, 34). The conductive intermediaries 46 may be located only on the first and second conductive films 32, 34. However, in some arrangements, such as the arrangement shown in FIG. 6C, the conductive intermediaries 46 may be located on the first and second conductive films 32, 34 and the electrodes 26, 28. With reference now to FIG. 6D, the conductive intermediaries 46 may be connected directly to the first and second transparent conductive substrates 12, 18 (e.g., in the electro-optic assembly 10C). The conductive intermediaries 46 may extend along one or more edges of the outer perimeter 44, for example, a single edge, opposite edges, or along substantially an entirety of the outer perimeter 44. In some embodiments, the concentration of the conduction paths 36A, 36B is greater and/or only located along the conductive intermediaries 46 and/or electrical contracts 36A, 36B.

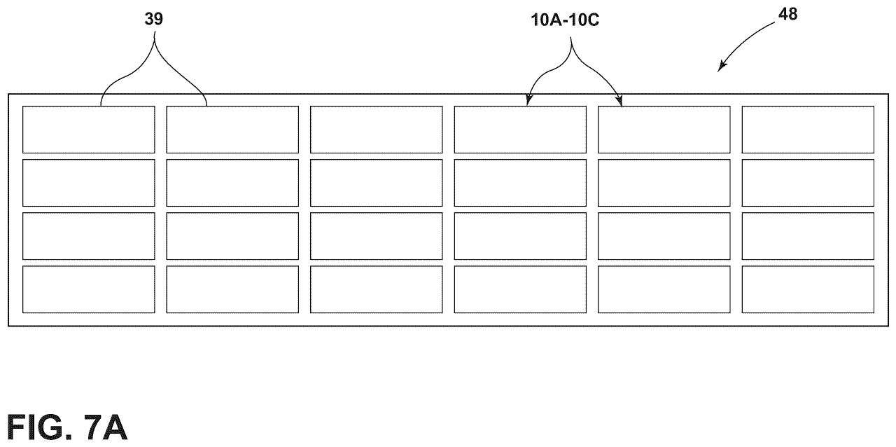

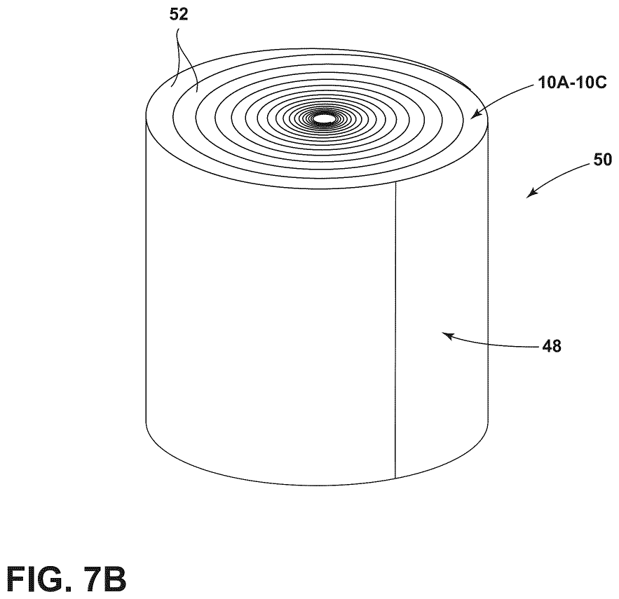

With reference now to FIG. 7A, a sheet 48 that is a preform template including elements (e.g., the stack) of the electro-optic assembly 10A-10C is illustrated. In some embodiments, the electro-optic assemblies 10A-10C have a non-uniform distribution of conduction paths 36A, 36B, the end applications may be designated or semi-designated, such that localized regions of the sheet 48 have greater concentrations of the conduction paths 36A, 36B. The localized regions may be arranged in a grid or other known patterns such that they can be cut to size prior to or after incorporation into the various structures 40A-40D and with the various arrangements of connecting the electrical contacts 37. In some embodiments, the electro-optic assemblies 10A-10C within the sheet 48 may be configured with the seal 39 to retain the electro-optic medium 30. In this manner, the sheet 48 may define an array of electro-optic assemblies 10A-10C each including a seal 39. Each of the electro-optic assemblies 10A-10C (e.g., seals 39) may include a variety of shapes, for example, to implement in the various structures 40A-40D. However, it should be appreciated that, in some embodiments, the electro-optic assemblies 10A-10C may not include the seal 39 and each electro-optic assembly 10A-10C can be cut to shape without limitation of the seal 39 (e.g., when the electro-optic medium 30 is solid-state or cut to shape and sealed in an inert environment at in an assembly environment).

With reference now to FIG. 7B, the sheet 48 may be formed into a roll 50 or folded and/or stacked with a plurality of turns 52 and/or otherwise packaged/stored as the sheet 48. The roll 50 and sheet 48 may be generically referred to as a template. Prior to incorporating the electro-optic assembly 10A-10C into one of the various structures 40A-40D, the roll 50 may be unrolled and cut (e.g., into a plurality of electro-optic assemblies 10A-10C), and shaped (e.g., flattened, curved, or formed into any shape). In some embodiments, the template may only comprise one of the substrates 12, 18 and may further include one of the first and second conductive films 32, 34 and the electrodes 26, 28 (FIG. 1). In some embodiments, the template may only comprise one of the substrates 12, 18 and may further include one of the first and second conductive films 32, 34 (FIG. 5A). In some embodiments, the template may only comprise one of the substrates 12, 18 and may further include one of the electrodes 26, 28 (FIG. 5B). It should be appreciated that while FIGS. 6C and 6D illustrate the substrate 12, 18 with conduction paths 36B, the substrate 12, 18 could, alternatively, include conduction paths 36A.

The disclosure herein is further summarized in the following paragraphs and is further characterized by combinations of any and all of the various aspects described therein.

According to one aspect of the present disclosure, an electro-optic assembly includes a first substrate that has a first surface and a second surface opposite the first surface and the first substrate is conductive from the first surface to the second surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode.

According to an aspect, a first substrate is anisotropically conductive.

According to another aspect, a first substrate defines a plurality of conduction paths electrically coupled between a first electrode and a first conductive film.

According to yet another aspect, a second substrate is conductive.

According to still yet another aspect, a second conductive film is coupled to a fourth surface of a second substrate.

According to another aspect, a first and a second substrate are anisotropically conductive.

According to yet another aspect, a first substrate defines a plurality of conduction paths. According to still yet another aspect, the conduction paths are non-uniformly spaced from one another.

According to another aspect, the conduction paths are formed with conductive elements suspended in a first substrate.

According to yet another aspect, the conduction paths are formed with conductive elements deposited in apertures defined by a first substrate.

According to still yet another aspect, a first conductive film coupled to one of a first surface or a fourth surface.

According to another aspect, a second conductive film coupled to the other of the first surface or the fourth surface.

According to still yet another aspect, a first and a second substrate each define a plurality of conduction paths.

According to another aspect of the present disclosure, an electro-optic assembly includes a first substrate that has a first surface and a second surface opposite the first surface and a plurality of conduction paths extending from the first surface to the second surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode.

According to another aspect, a plurality of conductive elements are located in each of a plurality of conduction paths, and the conductive elements are ferromagnetic.

According to yet another aspect, a conductive element is located in each of a plurality of conduction paths, and each of the conductive elements is formed of at least one of a conductive ink, a conductive epoxy, a conductive paste, a conductive adhesive, or a conductive polymer.

According to still yet another aspect, a second substrate includes a plurality of conduction paths extending from a third surface to a fourth surface.

According to another aspect, at least one of a first conductive film is coupled to a first surface or a second conductive film is coupled to a fourth surface.

According to yet another aspect of the present disclosure, an electro-optic assembly template includes a first substrate having a first surface and a second surface opposite the first surface and a plurality of conduction paths extending from the first surface to the second surface. At least one conductive element is located in each of the conduction paths, and a plurality of turns form a roll.

According to another aspect, an electro-optic assembly template includes at least two from a list comprising a first conductive film coupled to a first surface, a second conductive film coupled to a fourth surface, a first electrode coupled to a second surface, and a solid state electro-optic medium coupled to the second surface.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic assembly comprising:
a first substrate having a first surface and a second surface opposite the first surface and being conductive from the first surface to the second surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode.

2. The electro-optic assembly of claim 1, wherein the first substrate is anisotropically conductive.

3. The electro-optic assembly of claim 2, wherein the first substrate defines a plurality of conduction paths electrically coupled between the first electrode and a first conductive film.

4. The electro-optic assembly of claim 1, wherein the second substrate is conductive.

5. The electro-optic assembly of claim 4, wherein a second conductive film is coupled to the fourth surface.

6. The electro-optic assembly of claim 5, wherein the first and second substrates are anisotropically conductive.

7. The electro-optic assembly of claim 1, wherein the first substrate defines a plurality of conduction paths.

8. The electro-optic assembly of claim 7, wherein the conduction paths are non-uniformly spaced from one another.

9. The electro-optic assembly of claim 7, wherein the conduction paths are formed with conductive elements suspended in the first substrate.

10. The electro-optic assembly of claim 7, wherein the conduction paths are formed with conductive elements deposited in apertures defined by the first substrate.

11. The electro-optic assembly of claim 1, further including a first conductive film coupled to one of the first surface or the fourth surface.

12. The electro-optic assembly of claim 11, further including a second conductive film coupled to the other of the first surface or the fourth surface.

13. The electro-optic assembly of claim 1, wherein the first and second substrates each define a plurality of conduction paths.

14. An electro-optic assembly comprising:
a first substrate having a first surface and a second surface opposite the first surface and a plurality of conduction paths extending from the first surface to the second surface;
a second substrate having a third surface and a fourth surface opposite the third surface, the second and third surfaces facing each other to define a gap;
a first electrode coupled to the second surface;
a second electrode coupled to the third surface; and
an electro-optic medium located between the first electrode and the second electrode.

15. The electro-optic assembly of claim 14, wherein a plurality of conductive elements are located in each of the conduction paths, and the conductive elements are ferromagnetic.

16. The electro-optic assembly of claim 14, wherein a conductive element is located in each of the conduction paths, and each of the conductive elements is formed of at least one of a conductive ink, a conductive epoxy, a conductive paste, a conductive adhesive, or a conductive polymer.

17. The electro-optic assembly of claim 14, wherein the second substrate includes a plurality of conduction paths extending from the third surface to the fourth surface.

18. The electro-optic assembly of claim 17, further including at least one of a first conductive film coupled to the first surface or a second conductive film coupled to the fourth surface.

19. An electro-optic assembly template comprising:
a first substrate having a first surface and a second surface opposite the first surface and a plurality of conduction paths extending from the first surface to the second surface;
at least one conductive element located in each of the conduction paths; and
a plurality of turns forming a roll.

20. The electro-optic assembly template of claim 19, further including at least two from a list comprising:
a first conductive film coupled to the first surface, a second conductive film coupled to the fourth surface, a first electrode coupled to the second surface, and a solid state electro-optic medium coupled to the second surface.
